(19) United States
(12) Patent Application Publication
(10) Pub. No.: US 2006/0064587 A1
(43) Pub. Date: Mar. 23, 2006

(54) User activated authentication system

(76) Inventor: David Braverman, Rochester, NY (US)

Correspondence Address: CAMPBELL STEPHENSON ASCOLESE, LLP, 4807 SPICEWOOD SPRINGS RD., BLDG. 4, SUITE 201, AUSTIN, TX, 78759, US

(21) Appl. No.: 10/944,981

(22) Filed: Sep. 20, 2004

(51) Int. Cl. H04L 9/00

(52) U.S. Cl. 713/168

(57) ABSTRACT

An apparatus or method for authenticating a user's access to a device such as, for example, a garage. In one embodiment, the method includes a first device receiving an activation signal directly or indirectly from a user. The first device transmits a first signal to a second device in response to receiving the activation signal. The second device is coupled to a motor that opens or closes a door of the garage. In response to receiving the first signal, the second device transmits a second signal to the first device, wherein the second signal includes a randomly generated number. The first device encrypts the randomly generated number received from the second device to generate a first encrypted number. Thereafter the first device transmits a third signal to the second device, wherein the third signal includes the first encrypted number. In addition to sending the randomly generated number to the first device, the second device encrypts the randomly generated number to generate a second encrypted number. The second device compares the first and second encrypted numbers. If the first and second encrypted numbers compare equally, the second device instructs the garage door motor to open or close the garage door.

### BACKGROUND OF THE INVENTION

Garage door opener systems employ wireless communication to transmit radio frequency (RF) signals between one or more mobile units and a base unit. The mobile units are commonly small and may be carried on a key chain or they may be attached to a sun visor of an automobile. When a button is pressed on the mobile unit, the mobile unit transmits an RF signal to the base unit. The base unit is coupled to a garage door motor, which in turn is connected to a garage door. When the RF signal is received by the base unit, the base unit instructs the motor to engage and open or close the garage door.

Simple garage door opener systems are susceptible to unauthorized use by unscrupulous people. When the RF signal is transmitted by the mobile unit, it is possible for a person using electronic eavesdropping to record the RF signal. Later, a retransmission of the recorded RF signal can be used to open the garage door. Accordingly, there is a need for improved security in garage door opener systems to avoid unauthorized access via electronic eavesdropping and subsequent retransmission.

### SUMMARY OF THE INVENTION

An apparatus or method for authenticating a user's access to a device in a secure manner such as, for example, a garage. In one embodiment, the method includes a first device receiving an activation request signal directly or indirectly from a user. The first device transmits a first signal (i.e, a command) to a second device in response to receiving the activation request signal. In response to receiving the first signal, the second device transmits a second signal (i.e., a challenge) to the first device, wherein the second signal includes a randomly generated number. The first device receives the second signal and encrypts the randomly generated number contained therein to generate a first encrypted number. Thereafter the first device transmits a third signal (i.e., a response) to the second device, wherein the third signal includes the first encrypted number. In addition to sending the randomly generated number to the first device, the second device encrypts the randomly generated number to generate a second encrypted number. The second device compares the first and second encrypted numbers. The second device is coupled to a motor that opens or closes a door of the garage. If the first and second encrypted numbers compare equally, the second device deems the command as authentic and executes the authenticated command, for this example by instructing the garage door motor to open or close the garage door.

### BRIEF DESCRIPTION OF THE DRAWINGS

The present invention may be better understood, and its numerous objects, features, and advantages made apparent to those skilled in the art by referencing the accompanying drawings.

FIG. 1 is a block diagram illustrating relevant components of a garage door opener system employing one embodiment of the present invention.

FIG. 2 is a block diagram illustrating relevant components of the base and mobile units found in FIG. 1.

FIG. 3 is a flow chart illustrating relevant operational aspects of the user authentication process employed with the base and mobile units of FIG. 2 in accordance with one embodiment of the present invention.

The use of the same reference symbols in different drawings indicates similar or identical items.

### DETAILED DESCRIPTION

The present invention relates to an apparatus or method to prevent unauthorized access to devices such as garages, cars, computer systems, etc. The present invention will be described with reference to an apparatus or method to prevent unauthorized access to a garage via a garage door opener system, it being understood that the present invention should not be limited thereto. Indeed, the present invention can be used to authorize a communication channel between two communication devices.

FIG. 1 shows in block diagram form relevant components of garage door opener system 10 employing one embodiment of the present invention. More particularly, the system 10 shown within FIG. 1 includes a base unit 12 coupled to a mobile unit 14 via a communication link 16. Base unit 12 is coupled to a garage door motor 18 for opening or closing a garage door (not shown). Although not shown, base unit 12 is coupled to other mobile units via respective communication links.

Communication link 16 may take differing forms. For example, where the invention is used to prevent unauthorized access to a computer system, communication link 16 may take form in one or more optical fibers over which optical signals are transmitted between base unit 12 and mobile unit 14. Alternatively, communication link 16 may take form in one or more electrically conductive wires or traces on a printed circuit board over which electrical signals are transmitted between base unit 12 and mobile unit 14. In yet another embodiment, acoustic communication may occur between base unit 12 and mobile unit 14. In still yet another embodiment, a molecular based communication may be employed. In this latter embodiment, a protein snippet (acting as a command, which is more fully described below) could bond to the surface of another molecule/nanotube structure/DNA sequence, thereby starting a reaction (such as unzipping a DNA molecule) that releases another molecule/DNA snippet/nanotube structure (acting as the challenge, which is more fully described below). Detection (bonding to a mating molecule) of this released challenge molecule produces a response molecule. This embodiment may work with proteins, nanotube structures and possibly RNA and DNA molecules, for applications of targeted delivery of medications or authentication of a user by chemical means.

Notwithstanding the variety of communication mediums, for purposes of explanation it will be presumed that communication link 16 takes form in a wireless communication link over which RF signals are transmitted between base unit 12 and mobile unit 14 of a garage door opener system.

The RF signals are transmitted between base unit 12 and mobile unit 14 in accordance with a process to verify that the user in possession of the mobile unit 14 is authorized to open or close the garage door coupled to motor 18. In general the process includes mobile unit 14 transmitting a first signal (i.e, a command) to base unit 12 in response to receiving an activation signal from the user. In response to receiving the first signal, base unit 12 transmits a second signal (i.e., a challenge) to the mobile unit 14, wherein the second signal includes a randomly generated number. Mobile unit 14 receives the second signal and encrypts the randomly generated number contained therein to generate a first encrypted number. Thereafter mobile unit 14 transmits a third signal (i.e., a response) to the second device, wherein the third signal includes the first encrypted number. In addition to sending the randomly generated number to mobile unit 14, the base unit 12 encrypts the randomly generated number to generate a second encrypted number. Base unit 12 compares the first and second encrypted numbers. If the first and second encrypted numbers compare equally, base unit 12 instructs the garage door motor to open or close the garage door.

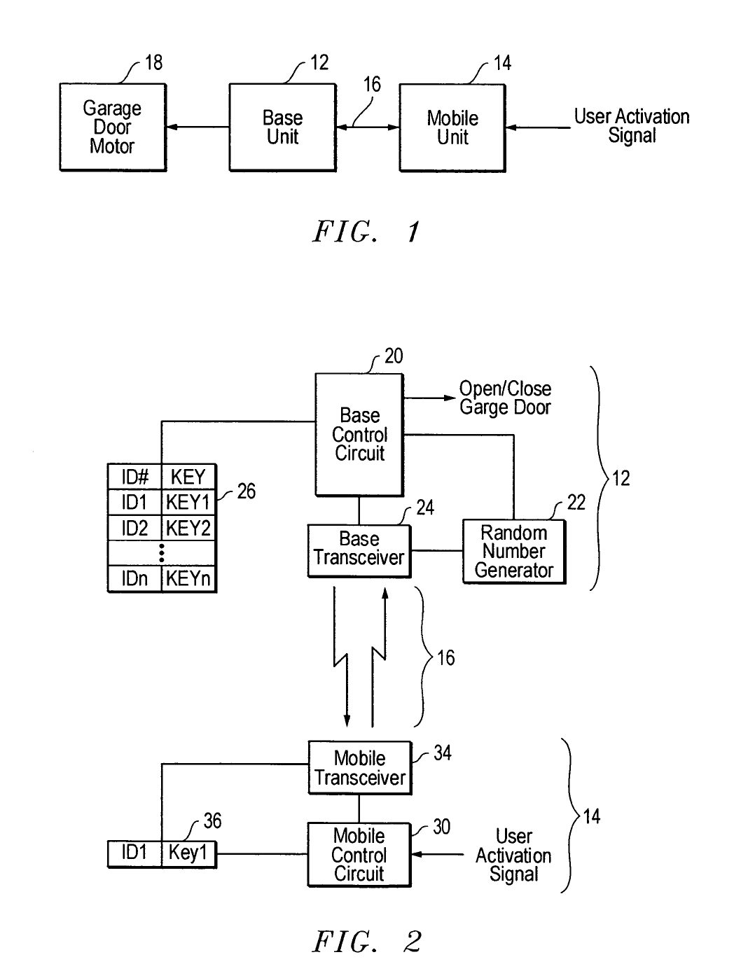

FIG. 2 illustrates in block diagram form, relevant components of the base unit 12 and mobile unit 14 shown in FIG. 1. In the embodiment shown in FIG. 2, the base unit 12 includes a base control circuit 20 coupled to a random number generator 22, a base transceiver 24, and base memory device 26. In one embodiment, base control circuit 20, random number generator 22, base transceiver 24, and/or base memory device 26 may be formed on a single semiconductor substrate. Ideally, base control circuit 20 and base memory device 26 should be formed on a single semiconductor substrate. Mobile unit 14 includes a mobile control circuit 30 coupled to a mobile transceiver 34 and mobile memory device 36. In one embodiment, mobile control circuit 30, mobile transceiver 34, and/or mobile memory device 36 may be formed on a single semiconductor substrate. Ideally, mobile control circuit 30 and mobile memory device 36 should be formed on a single semiconductor substrate.

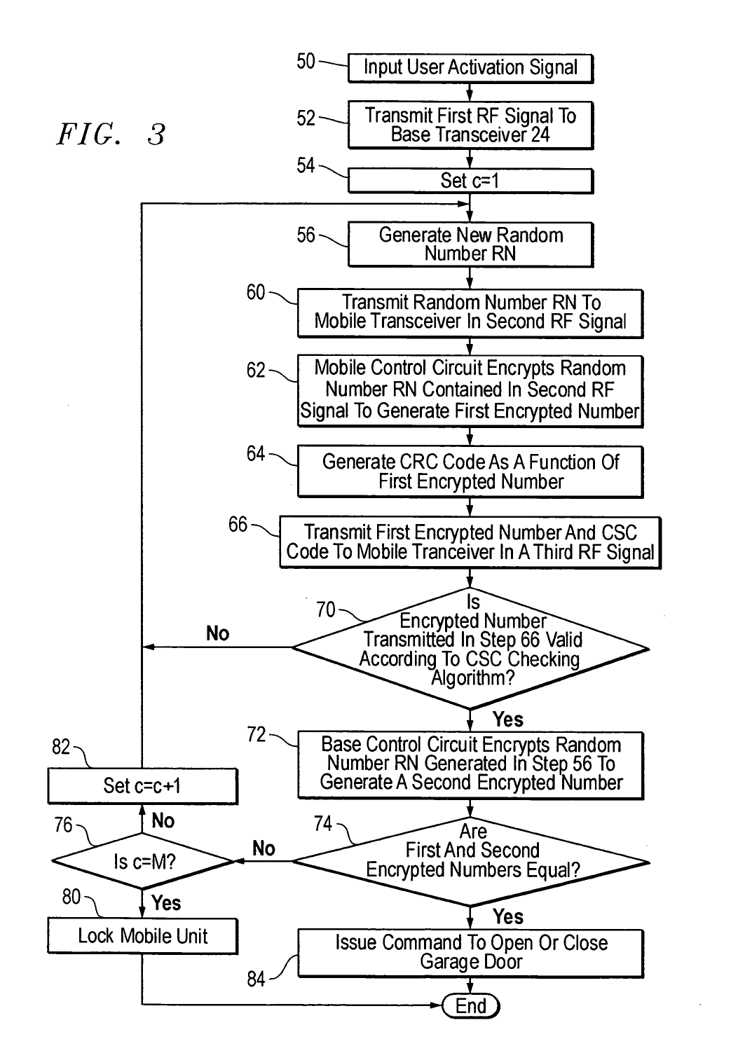

Base and mobile control circuits 20 and 30 may take form in processors or microcontrollers that execute instructions stored in an instruction memory (not shown). In an alternative embodiment, base and mobile control circuits 20 and 30 may take form in application specific integrated circuits. Still in a further embodiment, base and mobile control circuits 20 and 30 may take form in a combination of hardware and software. For purposes of explanation only, it will be presumed that base and mobile control circuits take from in microcontrollers that perform a variety of operations in response to executing instructions stored in memory. Operations performed by base control circuit 20 may include: encrypting random numbers generated by random number generator 22; comparing encrypted numbers generated by control circuits 20 and 30; checking the validity of encrypted numbers transmitted by mobile unit 14 using a cyclic redundancy check (CRC) algorithm; etc. Operations performed by mobile control circuit 30 may include: encrypting random numbers generated by random number generator 22; calculating CRC codes for encrypted numbers; etc. It is noted that control circuits 20 and 30 encrypt random numbers using identical encryption algorithms. Relevant operational aspects of control circuits 20 and 30 are described with reference to the process of FIG. 3.

Random number generator 22, as its name implies, generates random numbers on request. In one embodiment, a table may be configured in memory to store a number of sequentially generated random numbers. The random numbers of the table can be used in the order they were generated in the authentication process described below until all the random numbers have been used. At that point, random number generator may repopulate the random number table with a new set of randomly generated numbers. Random number generator 22 may or may not be pseudo random number generator.

Mobile and base transceivers 24 and 34 are capable of communicating with each other by transmitting or receiving RF signals via wireless link 16. These RF signals include information used in the process described below to authenticate a user's access to the garage door opener system 10. For example, base transceiver 24 is capable of sending an RF signal to mobile transceiver 24 containing a random number generated by random number generator 22. Mobile transceiver 34 is capable of sending an RF signal to base transceiver 24 containing an encrypted number generated by mobile control circuit 30. Transceivers 24 and 34 are also capable of extracting information from RF signals they receive and subsequently forwarding the extracted information to control circuits 20 and 30, respectively.

Base memory device 26 stores n entries that are accessible by base control circuit 20 and/or base transceiver 24. Each of the n entries includes a unique mobile unit identification (IDx) and a unique private encryption key (KEYx). The entries in base memory device 26 correspond to respective mobile units, only one of which (i.e., MU 14) is shown. Mobile memory device 36 stores an identification number (i.e., ID1) and private encryption key (KEY1) unique to mobile unit 14. As can be seen in FIG. 2, the identification number and encryption key pair stored in mobile unit 14 is identical to the identification number and private encryption key pair stored in the first entry of base memory device 26. Although not shown, each additional mobile unit that can effectively communicate with base unit 12 will have the same structure as mobile unit 14, including a mobile memory device. However, the mobile memory device of each of these additional mobile units would store a unique mobile unit identification number and private encryption key pair, a copy of which is also stored in a respective entry of base memory device 26. The private encryption keys are used by control circuits 20 and 30 to encrypt random numbers according to an encryption algorithm. Optionally, a single installation can use the same private encryption key for multiple mobile units that are installed at the same time.

Identification numbers and private encryption keys are generated and stored in memory devices 26 and 36 during an initialization process. In one embodiment of the initialization process, random number generator 22 provides base control circuit 20 with a seed random number. Base control circuit 20 generates an identification number (e.g., ID1) and a private encryption key (e.g., KEY1) as a function of the seed random number. The identification number and private encryption key generated by control circuit 20 during initialization process, is provided to base memory device 26 and stored therein as a separate entry. Additionally, the identification number and private encryption key generated by control circuit 20 during initialization process is provided to base transceiver 24 for subsequent transmission to mobile transceiver 34 via an initialization RF signal. Mobile transceiver 34 receives the initialization RF signal and extracts the identification number and private encryption key contained therein, and subsequently provides the extracted identification number and private encryption key to mobile memory device 36 for storage therein. It is noted that the extracted identification number and private encryption key may be provided to mobile memory device 36 via mobile control circuit 30. The initialization process is performed for each mobile unit designated for communication with base unit 12. Given that a seed random number is generated during the initialization process, each mobile unit will be assigned a unique identification number and private encryption key pair. Or, a unique identification number and the same private encryption key.

As noted above, base unit 12 and mobile unit 14 cooperate to verify a user's authority to remotely open and close the garage door (not shown). FIG. 3 is a flow chart illustrating relevant operational aspects of verifying a user's authority according to one embodiment of the present invention. Other embodiments are contemplated. The process in FIG. 3 is initiated in step 50 when mobile control unit 30 receives a user activation signal directly or indirectly from the user. This user activation signal may be provided to mobile control unit 30 when the user activates a switch (not shown), a button (not shown), or another device on or connected to the mobile unit 14. Once activated, the switch, button, or other device generates the user activation signal. Regardless of how the user activation signal is generated, the user activation signal is provided to mobile control circuit 30. In an alternative embodiment, mobile control circuit 30 may receive directly or indirectly from the user a signal that includes a command to perform some function (e.g., lock the garage door, activate or deactivate a light on the garage door motor, etc.) in addition to the user activation signal.

Mobile control circuit 30 in response to receiving the user activation signal, accesses mobile memory 36 to read identification number ID1. The identification number ID1 read from memory device 36 is provided directly or indirectly to mobile transceiver 34. For purposes of explanation only, it will be presumed that mobile control circuit 30 also provides a command to begin an authentication process (hereinafter the authentication command) to mobile transceiver 34 in response to receiving the user activation signal. Mobile control circuit 30 may also provide to transceiver 34 the additional command signal mentioned above.

Transceiver 34 generates a first RF signal. Transceiver transmits the first RF signal to base transceiver 24 via wireless link 16 as shown in step 52. In one embodiment, the first RF signal includes the identification number ID1 read from mobile memory device 36 and the authentication command provided by mobile control circuit 30. In another embodiment, the first RF signal may also include the additional command signal inputted to mobile control circuit 30 mentioned above.

Base transceiver 24 receives the first RF signal and extracts the identification ID1 and authentication command contained therein. The base transceiver 24 also extracts the additional command if included in the first RF signal. The extracted information is subsequently provided to base control circuit 20. It is noted that the additional command, if included in the first RF signal, may be stored in a command memory (not shown) of base circuit 20. Any prior command stored in the command memory is overwritten with the new additional command.

In response to receiving the authentication command from base transceiver 24, base control circuit, in one embodiment, may compare the identification ID1 received in the first RF signal with the identifications stored in memory device 26. If a match is found, base control circuit 20 begins its portion of the authentication process in response to the authentication command. If a match doesn't occur, base control circuit 20 will ignore the authentication command from base transceiver 24. In the alternative, base control circuit 20 may initiate its portion of the authentication process regardless of whether base control circuit 20 compares the identifications in memory device 26 with the identification ID1 received via the second RF signal. Presuming that base control circuit 20 does compare identification ID1 with the identifications stored in base memory device 26 and that a match occurs, base control circuit 20 begins the authentication process by setting a counter value c to 1 as shown in step 54. Random number generator 22 then generates a new random number RN (or reads the next unused random number in the random number table mentioned above) in response to a command from base control circuit 20 as shown in step 56. A CRC is calculated and attached to this random number. The random number RN+CRC is provided to base transceiver 24 from the base control circuit 20. Base transceiver 24 generates and transmits a second RF signal to transceiver 24 as shown in step 60. The second RF signal includes the random number RN generated in step 56.

Transceiver 34 of mobile unit 14 receives the second RF signal from transceiver 24. The random number RN contained in second RF signal is extracted from the second RF signal, checked for validity and subsequently provided to mobile control circuit 30. Control circuit 30 also reads the encryption key (KEY1) from mobile memory device 36 either before or after the second RF signal is received from base transceiver 24. Mobile control circuit 30, as shown within step 62, encrypts the random number RN using encryption key KEY1 in accordance with an encryption algorithm stored in memory to produce a first encrypted number. Exemplary well-known encryption algorithms include SHA-1, TEA, AES, 3DES, etc. In step 64, mobile control circuit 30 also calculates a cyclic redundancy check (CRC) code as a function of the first encrypted number. The first encrypted number and its corresponding CRC code are provided to mobile transceiver 34.

In step 66, mobile transceiver 34 generates a third RF signal which includes the first encrypted number and its corresponding CRC code generated in steps 62 and 64, respectively. It is noted that in an alternative embodiment, the third signal, rather than the first signal, may contain the identification number ID1 in addition to the first encrypted number and its corresponding CRC code. In any event, the third RF signal is transmitted to and subsequently received at base transceiver 24 via wireless link 16. Transceiver 24 receives the third RF signal and extracts the first encrypted number and its corresponding CRC code contained therein. The extracted first encrypted number and corresponding CRC code are provided to base control circuit 20.

One or more bits of the first encrypted number may have flipped during transmission of the third RF signal from transceiver 34 to transceiver 24. Base control circuit 20 checks the validity of the first encrypted number contained in the third RF message using the corresponding CRC code and a CRC checking algorithm. In step 70, if the CRC checking algorithm indicates that the encrypted number contained in the third RF signal is corrupted, process steps 56 through 70 are repeated. When base control circuit 20 in step 70 confirms the first encrypted number sent is valid, then base control circuit 20 reads the encryption key KEY1 from mobile memory device 26 corresponding to the mobile identification ID1 transmitted by mobile transceiver 34 in the first or third RF signal. In step 72, base control circuit 20 encrypts the random number RN generated in step 56 to generate a second encrypted number. Base control circuit 20 generates the second encrypted number using the encryption key KEY1 read from memory device 26 and an encryption algorithm identical to that used by control circuit 30. It is noted that in an alternative embodiment, base control circuit 20 encrypts the random number RN generated in step 56 while mobile control circuit 30 encrypts the random number it received from base unit 12.

In step 74, base control circuit 20 compares the second encrypted number it generated in step 72 with the valid, first encrypted number received in the third RF signal. If these encrypted numbers compare equally, then control circuit 20 generates a command for the garage door motor 18 to either open or close the garaged door connected thereto as shown in step 84. If, however, the first and second encrypted numbers do not compare equally in step 74, then the process proceeds to step 76 where base control circuit 20 compares c to a predetermined number M. If c=M in step 76, then base control circuit 20 locks base unit 12 for a period of time T. During the lock out period, no command is issued to garage door motor 18. If, however, c does not equal M in step 76, then c is incremented as shown in step 82 and the process steps 56-74 are repeated until a match is found between the encrypted numbers or c equals M. It is noted that if the first RF signal included an additional command, the base control circuit 20 will pass the additional command on to a device that is the target of the command if the first and second encrypted numbers match in step 74.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

I claim:

1. A method comprising:
a first device receiving an activation signal directly or indirectly from a user;
the first device transmitting a first signal to a second device in response to receiving the activation signal;
in response to receiving the first signal, the second device transmitting a second signal to the first device, wherein the second signal comprises a randomly generated number;
the first device encrypting the randomly generated number to generate a first encrypted number;
the first device transmitting a third signal to the second device, wherein the third signal comprises the first encrypted number;
the second device encrypting the randomly generated number to generate a second encrypted number;
the second device comparing the first and second encrypted numbers.

2. The method of claim 1 wherein the first device encrypts the randomly generated number according to an encryption algorithm, and wherein the second device encrypts the randomly generated number according to the encryption algorithm.

3. The method of claim 1 wherein each of the first, second, and third signals is transmitted wirelessly between the first and second devices.

4. The method of claim 1 wherein each of the first, second, and third signals is transmitted between the first and second devices using an optical transmission link.

5. The method of claim 1 wherein each of the first, second, and third signals is transmitted between the first and second devices using a radio frequency transmission link.

6. The method of claim 1 wherein each of the first, second, and third signals is transmitted between the first and second devices using an infrared transmission link.

7. The method of claim 1 wherein each of the first, second, and third signals is transmitted between the first and second devices using a acoustic transmission link.

8. The method of claim 1 wherein each of the first, second, and third signals is transmitted between the first and second devices using chemical transmission link.

9. The method of claim 1 further comprising:
the second device checking the validity of the first encrypted number contained in third signal using a cyclic redundancy check code.

10. The method of claim 1 wherein the first signal comprises an identification corresponding to the first device.

11. The method of claim 10 wherein the second device encrypts the randomly generated number using an encryption key corresponding to the identification.

12. An apparatus comprising:
a first device, wherein the first device comprises:
a first transceiver for transmitting signals to or receiving signals from a second transceiver;
a first circuit coupled to the first transceiver;
wherein the first transceiver is configured to transmit a first signal to the second transceiver in response to the first device receiving a command directly or indirectly from a user;
wherein the first transceiver is configured to receive a second signal from the second transceiver, wherein the second signal comprises a randomly generated number;
wherein the first circuit is configured to encrypt the randomly generated number to generate a first encrypted number;
wherein the first transceiver is configured to transmit a third signal to the second transceiver, wherein the third signal comprises the first encrypted number.

13. The apparatus of claim 12 wherein the first device further comprises a memory coupled to the first transceiver, wherein the memory is configured to store an identification of the first device, and wherein the first signal comprises the identification.

14. The apparatus of claim 12 further comprising:
a second device, wherein the second device comprises:
the second transceiver;
a second circuit coupled to the second transceiver;
a random number generator coupled to the second transceiver and the second circuit;
wherein the random number generator is configured to generate the randomly generated number in response to the second transceiver receiving the first signal;
wherein second circuit is configured to encrypt the randomly generated number to generate a second encrypted number;
wherein the second transceiver is configured to receive the third signal;
wherein the second transceiver is configured to transmit the second signal to the first receiver;
wherein the second circuit is configured to compare the first and second encrypted numbers.

15. The apparatus of claim 12 wherein the first circuit is configured to encrypt the randomly generated number according to an encryption algorithm, and wherein the second circuit is configured to encrypt the randomly generated number according to the encryption algorithm.

16. The apparatus of claim 12 wherein the first and second transceivers are configured to wirelessly transmit signals to each other.

17. The apparatus of claim 12 further comprising an optical transmission link coupled between the first and second transceivers, wherein the first, second, and third signals are transmitted via the optical transmission link.

18. A device comprising:
a transceiver for transmitting signals to or receiving signals from another transceiver;
a circuit;
a random number generator coupled to the transceiver and the circuit, wherein the random number generator is configured to generate a random number in response to the transceiver receiving a first signal, wherein the first signal comprises a device identification;
a memory for storing a plurality of encryption keys corresponding to a plurality of device identifications, respectively;
wherein the transceiver is configured to transmit a second signal to the other transceiver, wherein the second signal comprises the random number;
wherein the circuit is configured to encrypt the random number to generate a first encrypted number, wherein the circuit encrypts the random number using an encryption key stored in the memory that corresponds to the device identification;
wherein the transceiver is configured to receive a third signal, wherein the third signal comprises a second encrypted number;
wherein the circuit is configured to compare the first and second encrypted numbers.
